(19) United States
(12) Patent Application Publication
(10) Pub. No.: US 2004/0155877 A1
(43) Pub. Date: Aug. 12, 2004

(54) Image processing apparatus

(75) Inventors: Qi He Hong, Berkshire (GB); Adam Michael Baumberg, Berkshire (GB); Alexander Ralph Lyons, Berkshire (GB)

Correspondence Address: FITZPATRICK CELLA HARPER & SCINTO, 30 ROCKEFELLER PLAZA, NEW YORK, NY, 10112, US

(73) Assignee: CANON EUROPA N.V., Amstelveen (NL)

(21) Appl. No.: 10/771,416

(22) Filed: Feb. 5, 2004

(30) Foreign Application Priority Data
Feb. 12, 2003 (GB) 0303211.7

(51) Int. Cl. G06T 15/00

(52) U.S. Cl. 345/419

(57) ABSTRACT

In an image processing apparatus 2, images of a subject object 210 and data defining the positions and orientations at which the images were recorded are processed to generate a three-dimensional computer model of the subject object 210. As part of the processing, image data relating to the subject object 210 is segmented from other image data in each input image to define the silhouette of the subject object in each image, and the silhouettes are processed to generate the three-dimensional computer model. To improve the accuracy of the segmentation processing, and therefore the accuracy of each silhouette and the three-dimensional computer model, processing apparatus 2 defines a volume of three-dimensional space enclosing the subject object, projects the volume into at least one of the input images, selects pixels representative of the background by using the projection of the volume to prevent the selection of pixels representing the subject object, and uses the pixels to establish parameters to be used in the segmentation processing.

This application claims the right of priority under 35 USC § 119 based on British Patent Application number GB 0303211.7 filed 12 Feb. 2003, which is hereby incorporated by reference herein in its entirety as if fully set forth herein.

The present invention relates to the computer processing of image data defining images of an object recorded at different positions and orientations to generate a three-dimensional (3D) computer model of the object.

3D computer models of objects are useful for many applications. In particular, 3D computer models are often used in computer games and for computer aided design (CAD) applications. In addition, there is now a growing demand to have 3D computer models of objects for uses such as the embellishment of Internet sites etc.

Many methods are known for generating 3D computer models of objects. In particular, methods are known in which images of an object to be modelled are recorded at different positions and orientations. Each recorded image is then processed to calculate the position and orientation at which it was recorded (if not already known), and a 3D computer model of the object is generated using the input images and data defining the positions and orientations thereof.

Many techniques for processing images of a subject object to generate a 3D computer model thereof require each image to be processed to segment (separate) image data relating to the subject object from other image data (referred to as “background” image data). In this way, the silhouette (or outline) of the subject object is defined in each image and these silhouettes are then used to generate the 3D computer model. Such techniques include what is known as voxel carve processing, for example, as described in “Rapid Octree Construction from Image Sequences” by R. Szeliski in CVGIP: Image Understanding, Volume 58, Number 1, July 1993, pages 23-32, voxel colouring processing, for example, as described in University of Rochester Computer Sciences Technical Report Number 680 of January 1998 entitled “What Do N Photographs Tell Us About 3D Shape?” and University of Rochester Computer Sciences Technical Report Number 692 of May 1998 entitled “A Theory of Shape by Space Carving”, both by Kiriakos N. Kutulakos and Stephen M. Seitz, and silhouette intersection processing, for example as described in “Looking to Build a Model World: Automatic Construction of Static Object Models Using Computer Vision” by Illingworth and Hilton in IEE Electronics and Communication Engineering Journal, June 1998, pages 103-113 and “Automatic reconstruction of 3D objects using a mobile camera” by Niem in Image and Vision Computing 17 (1999) pages 125-134. The techniques also include the technique described in the proprietor's co-pending European patent application 02254027.2 (EP-A-1267309), the technique described in “A Volumetric Intersection Algorithm for 3D-Reconstruction Using a Boundary-Representation” by Martin Löhlein at http://i31www.ira.uka.de/diplomarbeiten/da_martin_loehlein/Reconstruction.html, and the technique described in “An Algorithm for Determining the Intersection of Two Simple Polyhedra” by M. Szilvasi-Nagy in Computer Graphics Forum 3 (1984) pages 219-225.

However, these methods suffer from a number of problems.

In particular, the accuracy of the 3D computer model of the subject object generated using each technique is dependent upon the accuracy of the silhouettes of the subject object generated in the starting images. Consequently, the accuracy of the 3D computer model is dependent upon the accuracy of the segmentation processing performed on each image to segment image data relating to the subject object from background image data.

Segmentation techniques for segmenting an image into pixels relating to the subject object and background pixels are based on processing the image to test pixel properties that have different values for the subject object and background, thereby enabling each pixel to be classified as a subject object pixel or a background pixel. Examples of such image features include pixel colours, image variation/uniformity over regions and image boundaries.

To perform such segmentation techniques to distinguish between the subject object pixels and background pixels, it is therefore necessary to know what values the image property being tested will have for any pixel or image region that belongs to the subject object and/or what values the image property will have for any pixel or image region that belongs to the background (allowing a pixel or image region to be classified as belonging to the subject object or background based on the value of the image property of the pixel). However, the image property values characteristic of the background and/or the image property values characteristic of the subject object may vary due to factors such as non-uniformity of the lighting condition, shadows, etc.

To determine the values, therefore, it is necessary to identify regions of a typical image which belong to the background and/or regions of the image which belong to the subject object and to test pixels or areas of these regions to determine values for the image property characteristic of the background and/or subject object so that the determined values can be used in the subsequent segmentation processing.

To do this, many known techniques assume that the subject object will be central in every image and that accordingly pixels near the edge of the image are background pixels. These techniques therefore select pixels near the edge of the image and test the selected pixels to determine the values of the image property to be used during segmentation processing as the characteristic values of background pixels. This technique suffers from a number of problems, however. In particular, if the subject object is near the edge of the image, then subject object pixels may be mistakenly selected as background pixels with the result that the values of the image property determined using the selected pixels are incorrect. This leads to inaccuracies in the segmentation processing and consequently inaccuracies in the 3D computer model generated using the results of the segmentation processing. A further problem arises in that the image properties of pixels near the edge of an image can be very different from those of pixels in the background region surrounding the object (for example if the subject object is imaged against a background screen which does not extend to the edge of each image). Again, this leads to inaccuracies in the determined values for background pixel with consequent inaccuracies in the results of the segmentation processing and the generated 3D computer model.

A human operator may be requested to identify characteristic background pixels in each image so that the identified pixels can be processed to determine the values of the image property of those pixels to be used in subsequent segmentation processing. However, this technique suffers from the problem that user input is required, which is time consuming and often inconvenient for the user.

The present invention aims to address one or more of the problems above.

According to the present invention characteristic values of background image data and/or subject object image data for use in segmentation processing of an image to distinguish between subject object image data and background image data are determined by calculating the two-dimensional projection in at least one image to be segmented of a three-dimensional volume which encloses the subject object, determining image property values of pixels at positions selected in dependence upon the position of the two-dimensional projection, and using the determined image property values to determine the values for use in the segmentation processing.

When the segmentation processing is performed, the two-dimensional projection may be used to exclude one or more parts of the image from segmentation processing and instead to classify the excluded part(s) as subject object or background image data without further tests.

The present invention provides apparatus and methods for use in performing the processing, and computer program products for enabling a programmable apparatus to become operable to perform the processing.

Embodiments of the invention will now be described, by way of example only, with reference to the accompanying drawings, in which like reference numbers are used to designate like parts, and in which:

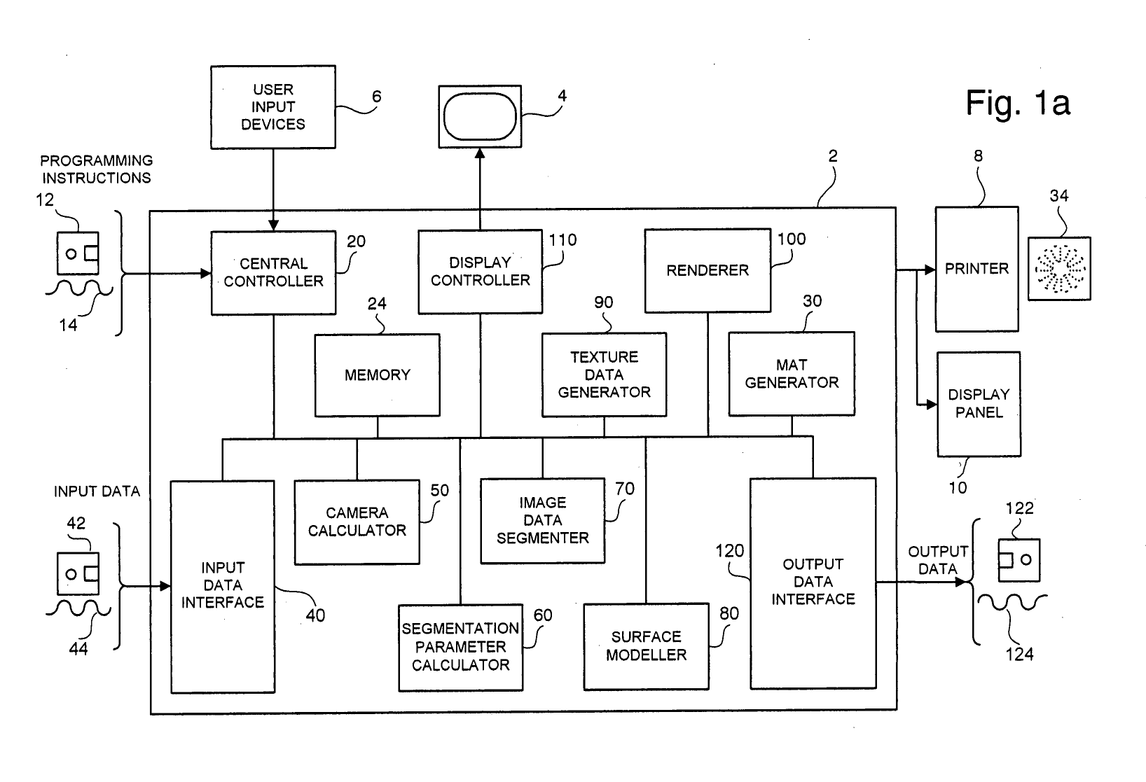

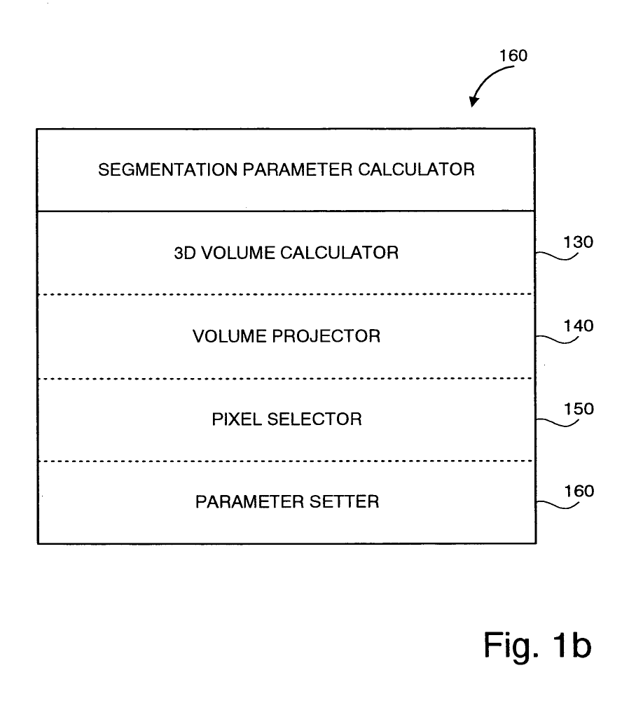

FIGS. 1a and 1b schematically show the components of an embodiment of the invention, together with the notional functional processing units into which the processing apparatus component may be thought of as being configured when programmed by programming instructions;

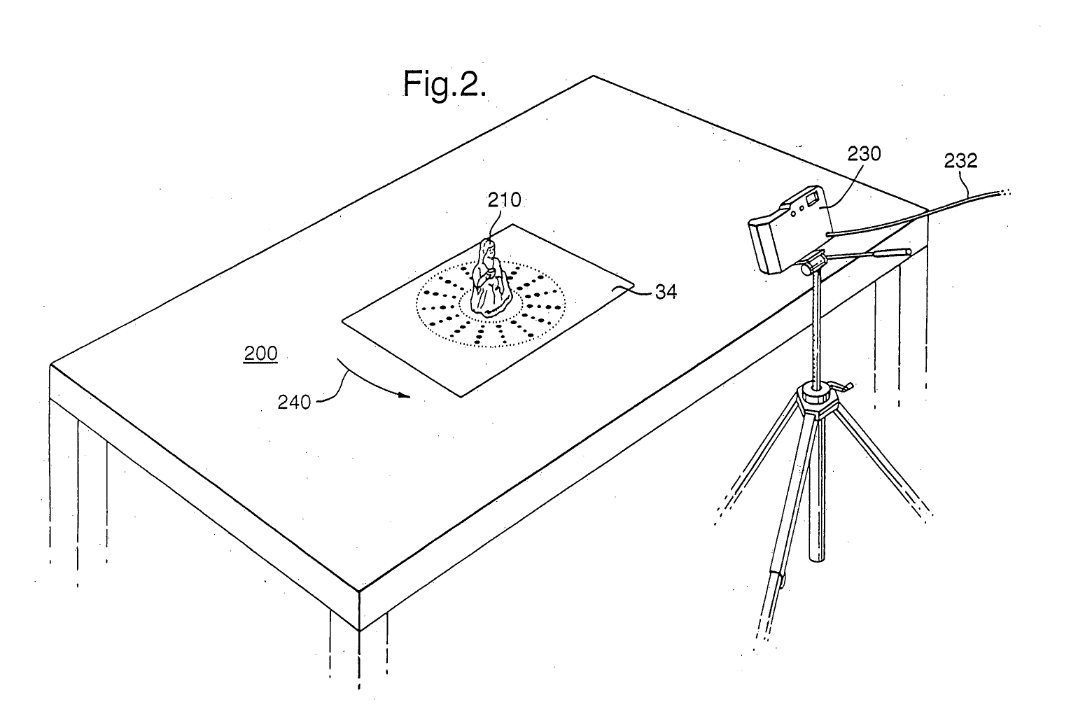

FIG. 2 illustrates the recording of images of a subject object for use in generating a 3D computer surface shape model of the subject object and texture data therefor;

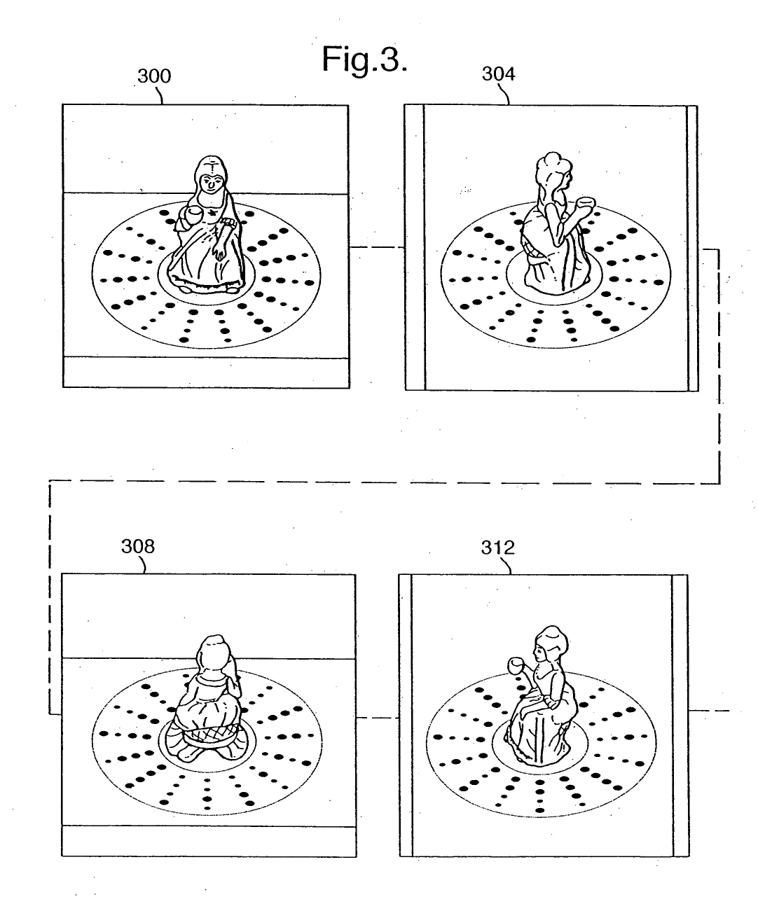

FIG. 3 shows examples of images of the subject object which are input to the processing apparatus in FIG. 1 and processed to generate a 3D computer surface shape model of the subject object and texture data therefor;

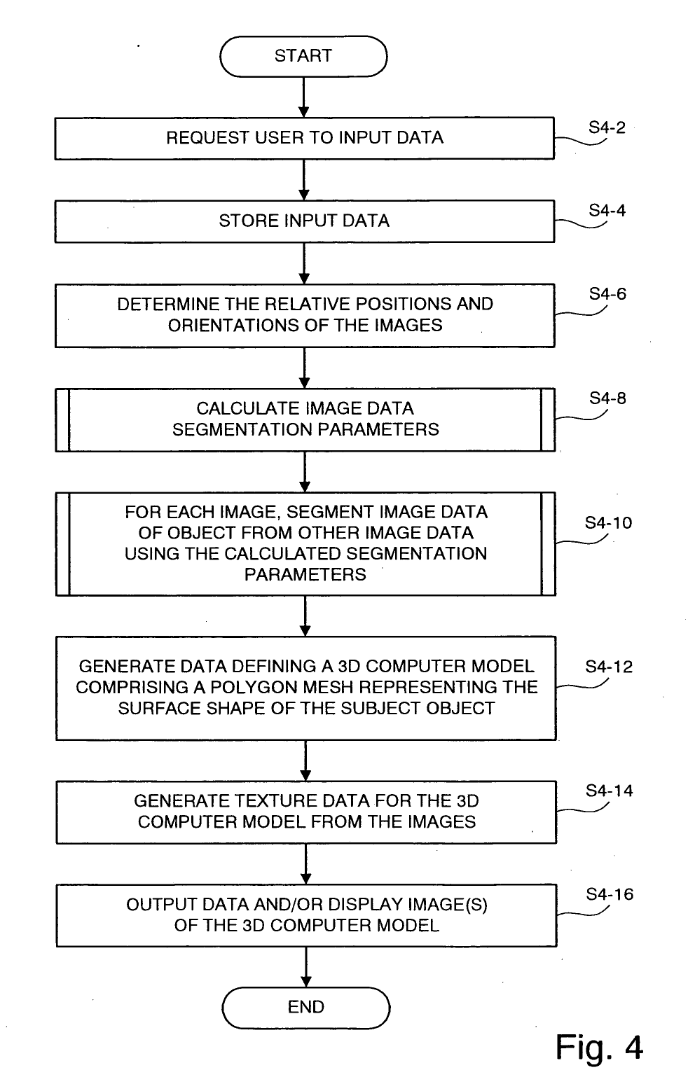

FIG. 4 shows the processing operations performed by the processing apparatus in FIG. 1 to process input data;

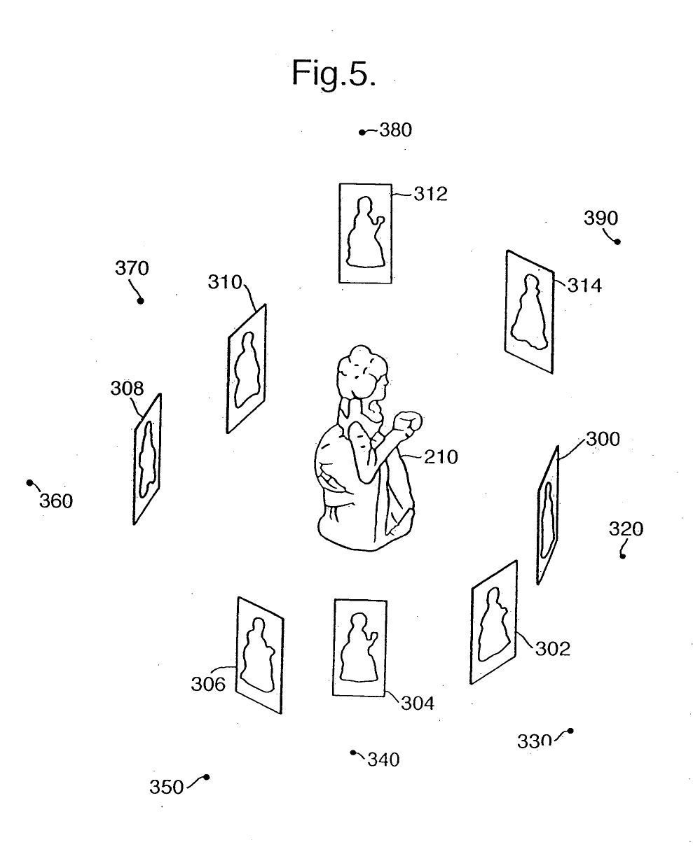

FIG. 5 shows an example to illustrate the recording positions, orientations and parameters for input images calculated as a result of the processing at step S4-6 in FIG. 4;

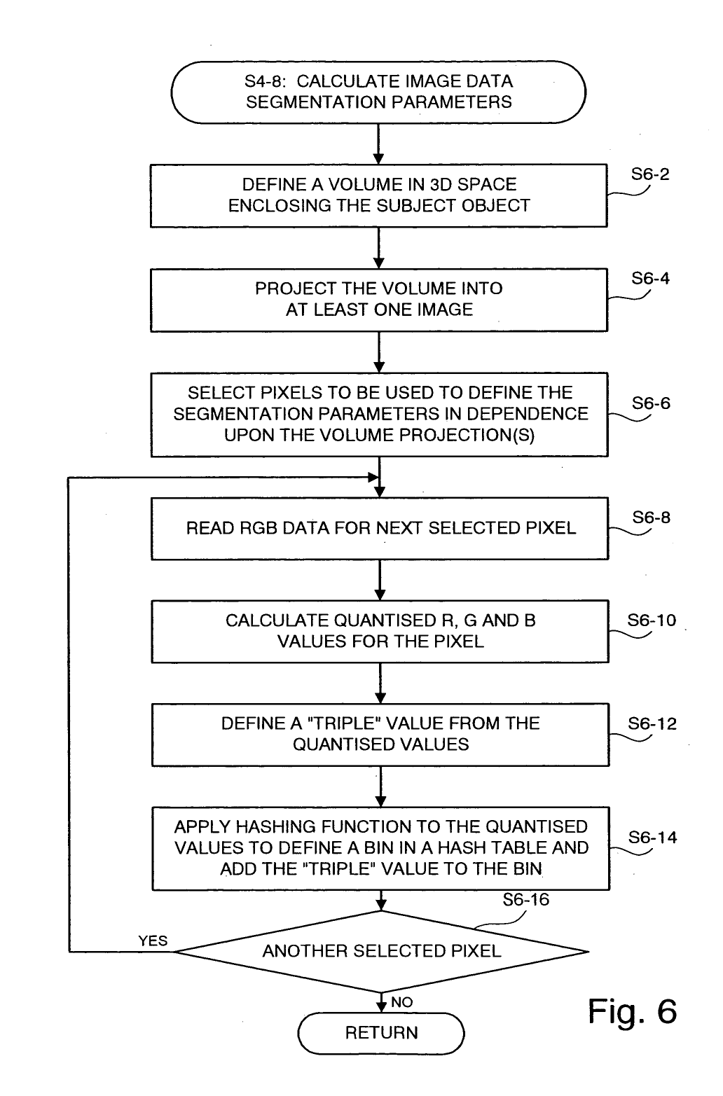

FIG. 6 shows the processing operations performed at step S4-8 in FIG. 4;

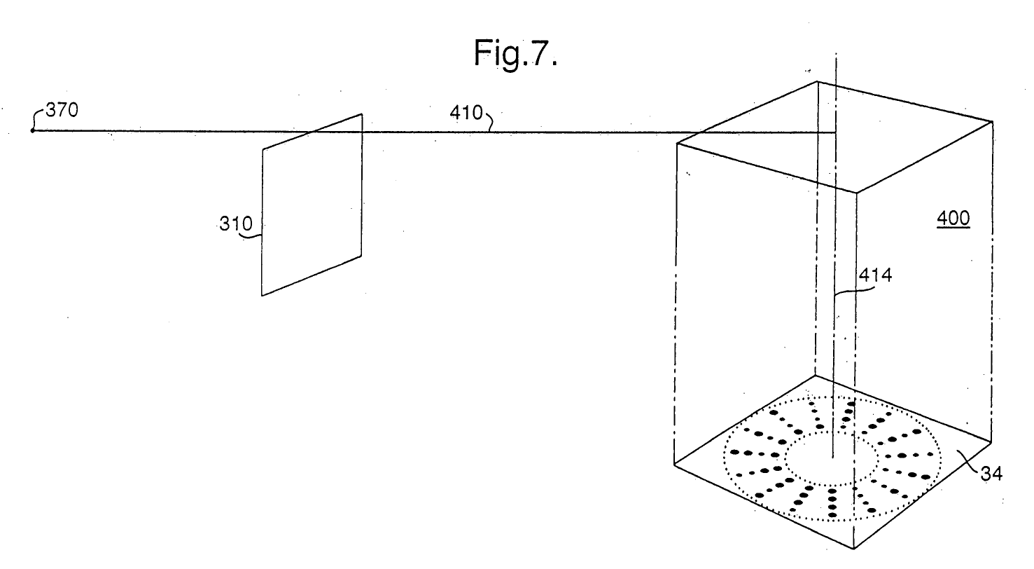

FIG. 7 shows an example to illustrate the processing performed at step S6-2 in FIG. 6;

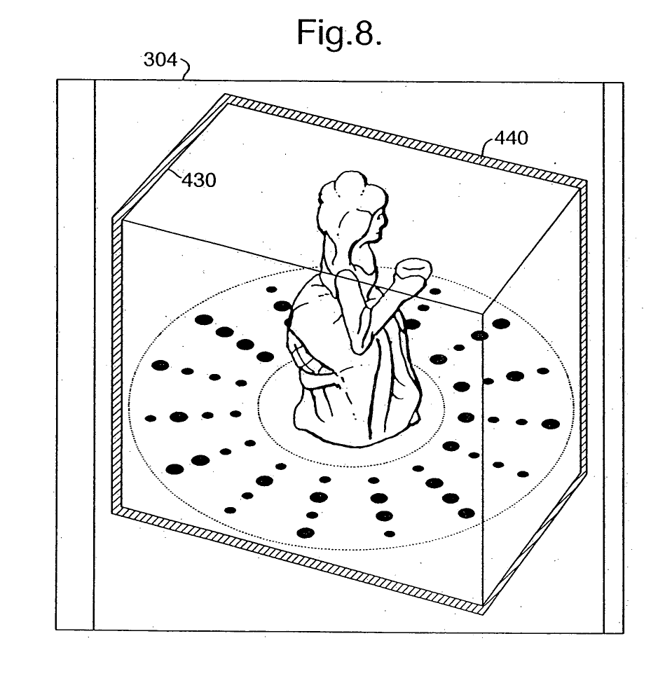

FIG. 8 shows an example to illustrate the processing performed at step S6-6 in FIG. 6; and

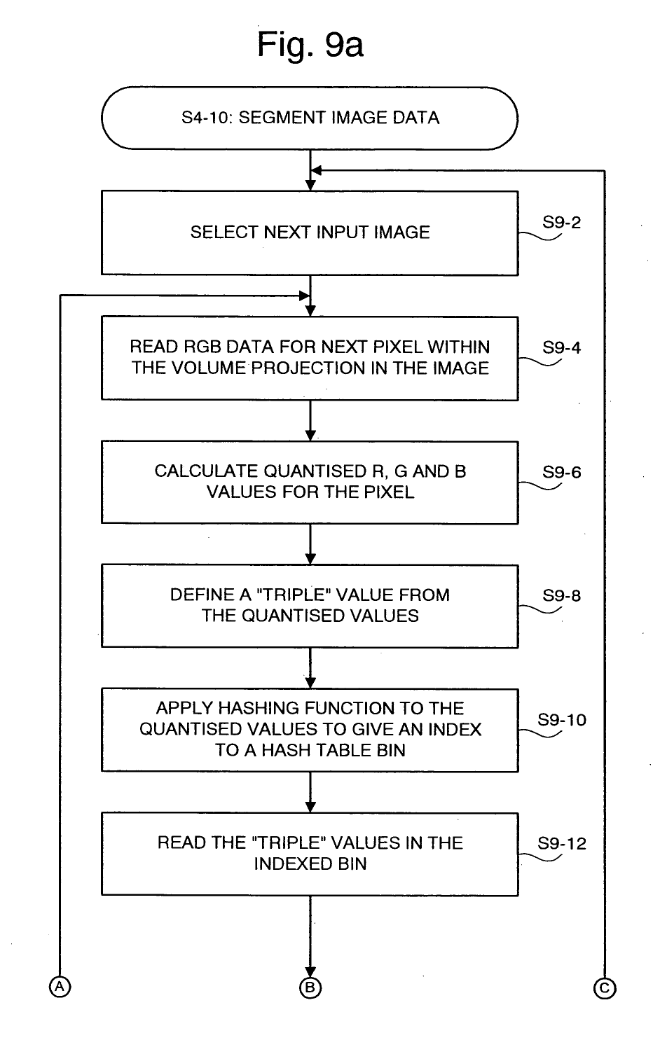

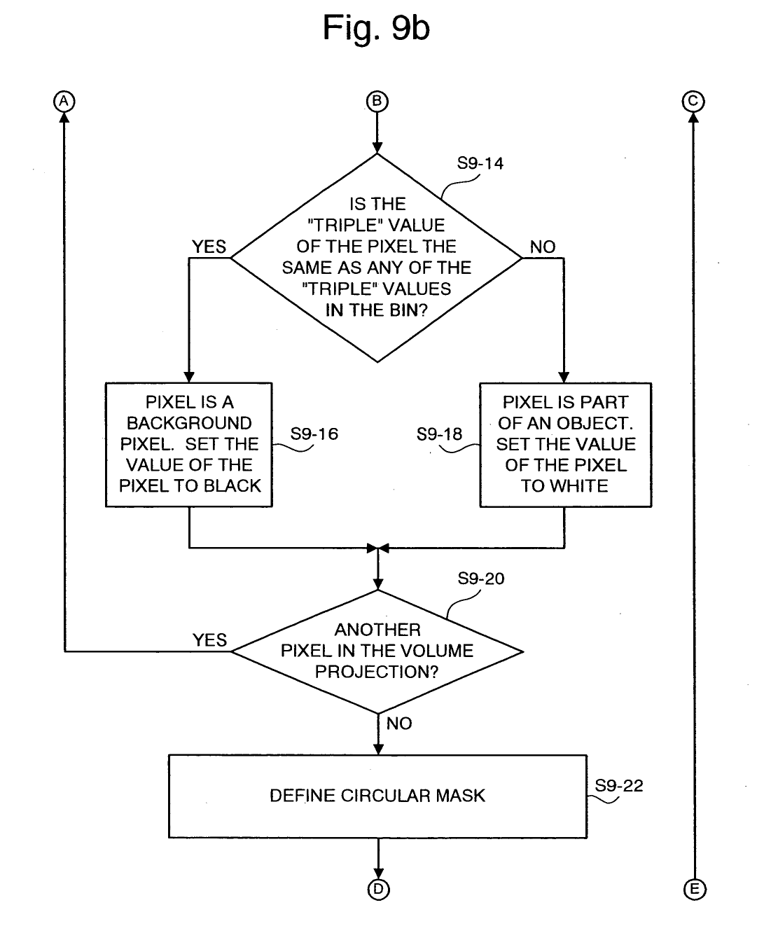

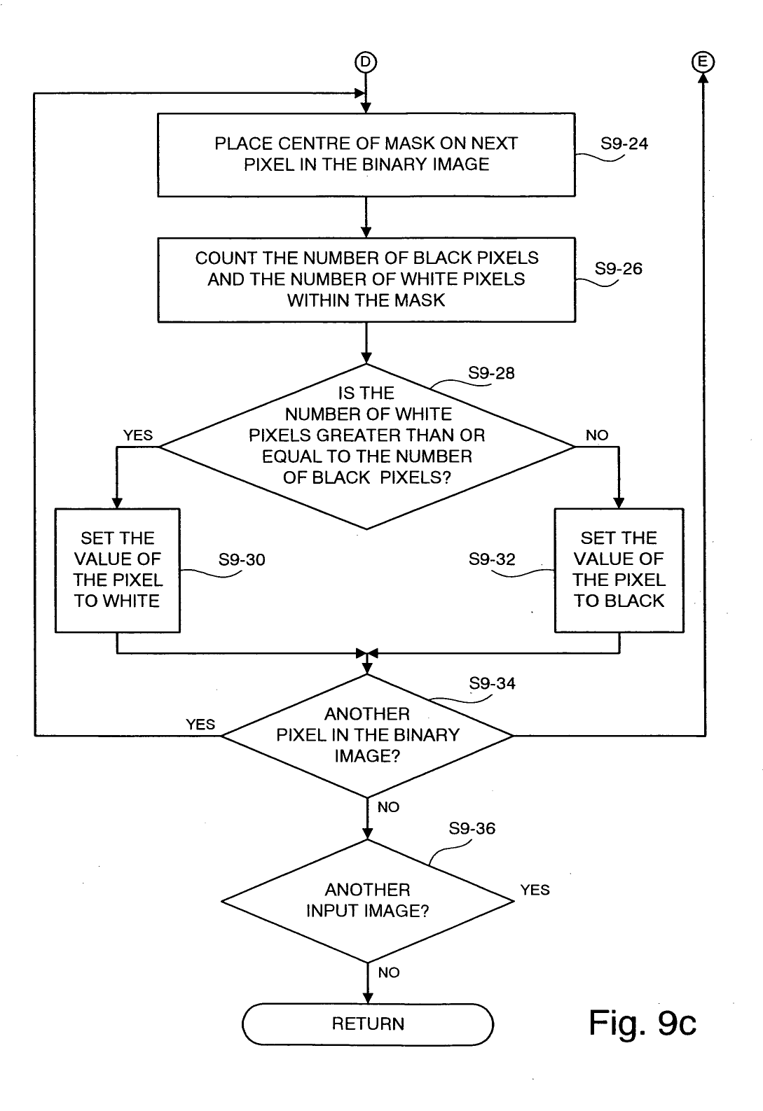

FIG. 9 shows the processing operations performed at step S4-10 in FIG. 4.

Referring to FIG. 1, an embodiment of the invention comprises a processing apparatus 2, such as a personal computer (PC), containing, in a conventional manner, one or more processors, memories, graphics cards etc, together with a display device 4, such as a conventional personal computer monitor, user input devices 6, such as a keyboard, mouse etc, a printer 8, and a display panel 10 comprising a flat panel having controllable pixels, such as the PL400 manufactured by WACOM.

The processing apparatus 2 is programmed to operate in accordance with programming instructions input, for example, as data stored on a data storage medium 12, (such as an optical CD ROM, semiconductor ROM, magnetic recording medium, etc), and/or as a signal 14 (for example an electrical or optical signal input to the processing apparatus 2, for example from a remote database, by transmission over a communication network such as the Internet or by wireless transmission through the atmosphere), and/or entered by a user via a user input device 6 such as a keyboard.

As will be described in more detail below, the programming instructions comprise instructions to cause the processing apparatus 2 to become configured to generate data defining a 3D computer model of the surface shape of a subject object by processing input data defining images of the subject object recorded at different positions and orientations relative thereto. To generate the 3D computer model of the surface shape of the subject object, processing apparatus 2 performs segmentation processing on each input image to separate image data relating to the subject object from other image data (“background” image data), thereby defining a silhouette of the subject object in each input image. The silhouettes are then used to generate the 3D computer surface shape model. To improve the accuracy of the segmentation processing (and hence the accuracy of each silhouette) without the requirement for user intervention, processing apparatus 2 defines a volume of three-dimensional space enclosing the subject object, projects the volume into at least one of the input images, selects pixels representative of the background by using the projection of the volume to prevent the selection of pixels representing the subject object, and uses the selected pixels to establish parameters to be used in the segmentation processing to distinguish background pixels from subject object pixels in each input image.

In this embodiment, the subject object is imaged on a calibration object (a two-dimensional photographic mat in this embodiment) which has a known pattern of features thereon. The input images to be used to generate the 3D computer surface model comprise images recorded at different positions and orientations of the subject object and the calibration object in a fixed respective configuration (that is, the position and orientation of the subject object relative to the calibration object is the same for the images). The positions and orientations at which the input images were recorded are calculated by detecting the positions of the features of the calibration object pattern in the images.

When programmed by the programming instructions, processing apparatus 2 can be thought of as being configured as a number of functional units for performing processing operations. Examples of such functional units and their interconnections are shown in FIGS. 1a and 1b. The units and interconnections illustrated in FIGS. 1a and 1b are, however, notional, and are shown for illustration purposes only to assist understanding; they do not necessarily represent units and connections into which the processor, memory etc of the processing apparatus 2 actually become configured.

Referring to the functional units shown in FIG. 1a, a central controller 20 is arranged to process inputs from the user input devices 6, and also to provide control and processing for the other functional units.

Memory 24 is provided to store the operating instructions for the processing apparatus, to store data input to the processing apparatus, and to store data generated by central controller 20 and the other functional units.

Mat generator 30 is arranged to generate control signals to control printer 8 or to control display panel 10 to print a calibration pattern on a recording medium such as a piece of paper to form a printed “photographic mat” 34 or to display the calibration pattern on display panel 10 to display a photographic mat. As will be described in more detail below, the photographic mat comprises a predetermined calibration pattern of features, and the subject object for which a 3D computer model is to be generated is placed on the printed photographic mat 34 or on the display panel 10 on which the calibration pattern is displayed. Images of the subject object and the calibration pattern are then recorded and input to the processing apparatus 2 for use in generating the 3D computer surface shape model and texture data therefor. These images comprise images recorded from different positions and orientations relative to the subject object and calibration pattern, with the position and orientation of the subject object relative to the calibration pattern being the same for all images to be used to generate the 3D computer surface shape model.

Mat generator 30 is arranged to store data defining the calibration pattern of features printed or displayed on the photographic mat for use by the processing apparatus 2 when calculating the positions and orientations at which the input images were recorded. More particularly, in this embodiment, mat generator 30 is arranged to store data defining the pattern of features together with a coordinate system relative to the pattern of features (which, in effect, defines a reference position of orientation of the calibration pattern), and processing apparatus 2 is arranged to calculate the positions and orientations at which the input images were recorded in the defined coordinate system (and thus relative to the reference position and orientation). In this way, the recording positions and orientations of the input images are calculated relative to each other, and accordingly a registered set of input images is generated.

In this embodiment, the calibration pattern on the photographic mat comprises spatial clusters of features, for example as described in PCT Application GB00/04469 (WO-A-01/39124) (the full contents of which are incorporated herein by cross-reference) or any known pattern of features, such as a pattern of coloured dots, with each dot having a different hue/brightness combination so that each respective dot is unique (for example, as described in JP-A-9-170914), a pattern of concentric circles connected by radial line segments with known dimensions and position markers in each quadrant (for example, as described in “Automatic Reconstruction of 3D Objects Using a Mobile Camera” by Niem in Image and Vision Computing 17, 1999, pages 125-134), or a pattern comprising concentric rings with different diameters (for example as described in “The Lumigraph” by Gortler et al in Computer Graphics Proceedings, Annual Conference Series, 1996 ACM-0-89791-764-4/96/008).

In the remainder of the description of this embodiment, it will be assumed that the calibration pattern is printed by printer 8 on a recording medium (in this embodiment, a sheet of paper) to generate a printed photographic mat 34, although, as mentioned above, the calibration pattern could be displayed on display panel 10 instead.

Input data interface 40 is arranged to control the storage of input data within processing apparatus 2. The data may be input to processing apparatus 2 for example as data stored on a storage medium 42, as a signal 44 transmitted to the processing apparatus 2, or using a user input device 6. In this embodiment, the input data defines a plurality of images of the subject object on the photographic mat 34 recorded at different positions and orientations relative thereto. In addition, in this embodiment, the input data also includes data defining the intrinsic parameters of the camera which recorded the input images, that is, the aspect ratio, focal length, principal point (the point at which the optical axis intersects the imaging plane), first order radial distortion coefficient, and skew angle (the angle between the axes of the pixel grid; because the axes may not be exactly orthogonal).

The input data defining the input images may be generated, for example, by downloading pixel data from a digital camera which recorded the images, or by scanning photographs using a scanner (not shown).

The input data defining the intrinsic camera parameters may be input by a user using a user input device 6.

Camera calculator 50 is arranged to process each input image to be used to generate the 3D computer surface shape model to detect the positions in the image of the features in the calibration pattern of the photographic mat 34 and to calculate the position and orientation of the camera relative to the photographic mat 34 when the image was recorded. In this way, because the position and orientation of each input image is calculated relative to the same calibration pattern, the positions and orientations of the input images are defined in a common coordinate system and therefore a registered set of input images is generated.

Segmentation parameter calculator 60 is arranged to process at least one of the input images to calculate parameters for use in segmentation processing to segment subject object pixels from background pixels in each input image to be used to generate the 3D compute surface shaped model.

Referring to FIG. 1b, in this embodiment, segmentation parameter calculator 60 comprises 3D volume calculator 130, volume projector 140, pixel selector 150, and parameter setter 160.

3D volume calculator 130 is arranged to generate data defining a volume of three-dimensional space such that the subject object to be modelled lies wholly within the defined volume.

Volume projector 140 is arranged to project the 3D volume defined by 3D volume calculator 130 into at least one of the input images.

Pixel selector 150 is arranged to determine the outer perimeter of the projection of the 3D volume in each input image into which the volume is projected by volume projector 140. Pixel selector 150 is further arranged to select pixels lying outside the determined perimeter to be used as the pixels to define parameters for the segmentation processing.

Parameter setter 160 is arranged to set the parameters for segmentation processing to distinguish background pixels from subject object pixels in each input image based on the properties of the pixels selected by pixel selector 150.

Referring again to FIG. 1a, image data segmenter 70 is arranged to perform segmentation processing on each input image to segment pixels relating to the subject object from other pixels (referred to as “background” pixels), thereby generating data defining a silhouette of the subject object in each input image. During this processing, image data segmenter 70 distinguishes between subject object pixels and background pixels based on the segmentation parameters defined by segmentation parameter calculator 60.

Surface modeller 80 is arranged to process the segmented image data of the subject object in each input image generated by image data segmenter 70 and the image positions and orientations calculated by camera calculator 50 for the images, to generate data defining a 3D computer model comprising a polygon mesh representing the surface of the subject object.

Texture data generator 90 is arranged to generate texture data from the input images for rendering onto the 3D computer model generated by surface modeller 80.

Renderer 100 is arranged to generate data defining an image of the 3D computer surface model generated by surface modeller 80 in accordance with a virtual camera, the processing performed by renderer 100 being conventional rendering processing and including rendering texture data generated by texture data generator 90 onto the 3D computer surface model.

Display controller 110 is arranged to control display device 4 to display images and instructions to the user during the processing by processing apparatus 2. In addition, display controller 110 is arranged to control display device 4 to display the image data generated by renderer 100 showing images of the 3D computer surface model rendered with the texture data generated by texture data generator 90.

Output data interface 120 is arranged to control the output of data from processing apparatus 2. In this embodiment, the output data defines the 3D computer surface shape model generated by surface modeller 70 and the texture data generated by texture data generator 100. Output data interface 120 is arranged to output the data for example as data on a storage medium 122 (such as an optical CD ROM, semiconductor ROM, magnetic recording medium, etc), and/or as a signal 124 (for example an electrical or optical signal transmitted over a communication network such as the Internet or through the atmosphere). A recording of the output data may be made by recording the output signal 124 either directly or indirectly (for example by making a first recording as a “master” and then making a subsequent recording from the master or from a descendant recording thereof) using recording apparatus (not shown).

Referring now to FIG. 2, the recording of input images for processing by processing apparatus 2 to generate a 3D computer surface shape model will be described.

The printed photographic mat 34 is placed on a surface 200, and the subject object 210 for which a 3D computer model is to be generated, is placed substantially at the centre of the photographic mat 34 so that the subject object 210 is surrounded by the features making up the calibration pattern on the mat.

Images of the subject object 210 and photographic mat 34 are recorded at different positions and orientations relative thereto to show different parts of the subject object 210 using a digital camera 230. In this embodiment, data defining the images recorded by the camera 230 is input to the processing apparatus 2 as a signal 44 along a wire 232.

More particularly, in this embodiment, camera 230 remains in a fixed position, and the photographic mat 34 with the subject object 210 thereon is moved (translated) and rotated (for example, in the direction of arrow 240) on surface 200 and photographs of the object 210 at different positions and orientations relative to the camera 230 are recorded. During the rotation and translation of the photographic mat 34 on surface 200 to record the images to be used to generate the 3D computer surface shape model, the subject object 210 does not move relative to the mat 34, so that the position and orientation of the subject object 210 relative to the calibration pattern is the same for each image.

Images of the top of the subject object 210 are recorded by removing the camera 230 from the tripod and imaging the subject object 210 from above.

FIG. 3 shows examples of images 300, 304, 308 and 312 from a set of images defined by data input to processing apparatus 2 for processing to generate the 3D computer surface shape model, the images showing the subject object 210 and photographic mat 34 in different positions and orientations relative to camera 230.

FIG. 4 shows the processing operations performed by processing apparatus 2 to process the input data in this embodiment.

Referring to FIG. 4, at step S4-2, central controller 20 causes display controller 110 to display a message on display device 4 requesting the user to input data for processing to generate a 3D computer surface shape model.

At step S4-4, data input by the user in response to the request at step S4-2 is stored in memory 24 under the control of input data interface 40. More particularly, as described above, in this embodiment, the input data comprises data defining images of the subject object 210 and photographic mat 34 recorded at different relative positions and orientations, together with data defining the intrinsic parameters of the camera 230 which recorded the input images.

At step S4-6, camera calculator 50 processes the input image data and the intrinsic camera parameter data stored at step S4-4, to determine the position and orientation of the camera 230 relative to the calibration pattern on the photographic mat 34 (and hence relative to the subject object 210) for each input image. This processing comprises, for each input image, detecting the features in the image which make up the calibration pattern on the photographic mat 34, comparing the positions of the features in the image to the positions of the features in the stored pattern for the photographic mat, and calculating therefrom the position and orientation of the camera 230 relative to the mat 34 when the image was recorded. The processing performed by camera calculator 50 at step S4-6 depends upon the calibration pattern of features used on the photographic mat 34. Accordingly, suitable processing is described, for example, in co-pending PCT Application GB00/04469 (WO-A-01/39124), JP-A-9-170914, “Automatic Reconstruction of 3D Objects Using a Mobile Camera” by Niem in Image and Vision Computing 17, 1999, pages 125-134, and “The Lumigraph” by Gortler et al in Computer Graphics Proceedings, Annual Conference Series, 1996 ACM-0-89791-764-4/96/008. It should be noted that the positions of the features of the calibration pattern in each input image may be identified to processing apparatus 2 by the user (for example, by pointing and clicking on each calibration pattern feature in displayed images) rather than being detected independently by camera calculator 50 using the image processing techniques in the listed references.

The result of the processing by camera calculator 50 at step S4-6 is that the position and orientation of each input image has now been calculated relative to the calibration pattern on the photographic mat 34, and hence relative to the subject object 210.

Thus, referring to FIG. 5, at this stage in the processing, processing apparatus 2 has data stored therein defining a plurality of images 300-314 of a subject object 210, data defining the relative positions and orientations of the images 300-314 in 3D space, and data defining the imaging parameters of the images 300-314, which defines, inter alia, the focal point positions 320-390 of the images.

Referring again to FIG. 4, at step S4-8, segmentation parameter calculator 60 performs processing to calculate parameters to be used in subsequent processing by image data segmenter 70 to segment image data relating to the subject object 210 from background image data in each input image 300-314.

FIG. 6 shows the processing operations performed by segmentation parameter calculator 60 at step S4-8.

Referring to FIG. 6, at step S6-2, 3D volume calculator 130 defines a volume in the three-dimensional coordinate system in which the positions and orientations of the images 300-314 were calculated at step S4-6. 3D volume calculator 130 defines the volume such that the subject object 210 lies wholly inside the volume.

Referring to FIG. 7, in this embodiment, the volume defined by 3D volume calculator 130 at step S6-2 comprises a cuboid 400 having vertical side faces and horizontal top and bottom faces. The vertical side faces are positioned so that they touch the edge of the calibration pattern of features on the photographic mat 34 (and therefore wholly contain the subject object 210). The position of the top face of the cuboid 400 is set at a position defined by the intersection of a straight line 410 from the focal point position of camera 230 for any of the input images 300-314 through the top edge of the image with a vertical line 414 through the centre of the photographic mat 34. This is illustrated in FIG. 7 for a line 410 from the focal point position 370 through the top edge of image 310. The focal point positions of the camera 230 and the top edge of each image are known as a result of the position and orientation calculations performed at step S4-6 by camera calculator 50. By setting the height of the top face to correspond to the point where the line 410 intersects the vertical line 414 through the centre of the photographic mat 34, the top face of the cuboid 400 will always be above at the top of the subject object 210 in 3D space (provided that the top of the subject object 210 is visible in the input image used to define the position of the top face).

The position of the horizontal base face of the cuboid 400 is set to be the same as the plane of the photographic mat 34, thereby ensuring that the subject object 210 will always be above the base face of the cuboid 400.

Referring again to FIG. 6, at step S6-4, volume projector 140 projects the volume defined in step S6-2 (that is, cuboid 400 in the example of FIG. 7) into at least one input image. In this embodiment, volume projector 140 projects the volume into every input image, although the volume may be projected, instead, into only one input image or a subset containing two or more input images.

At step S6-6, pixel selector 150 selects pixels from each input image into which the volume is projected at step S6-4 as pixels to be used to define the segmentation parameters.

Referring to FIG. 8, in this embodiment, the processing performed by pixel selector 150 at step S6-6 comprises processing to identify the outer perimeter 430 of the projection of the volume in each input image (this being illustrated for input image 304 in the example of FIG. 8), and processing to select each pixel which lies wholly within a region 440 comprising a strip of predetermined widths (set to ten pixels in this embodiment) around the outside of the outer perimeter 430 of the projected volume.

By selecting pixels in dependence upon the projected volume in this way, each selected pixel is guaranteed not to be a subject object pixel because the volume was defined at step S6-2 to enclose the subject object 210 and each pixel selected at step S6-6 is outside the projection of the volume.

Consequently, the processing by 3D volume calculator 130, volume projector 140 and pixel selector 150 at steps S6-2 to S6-6 provides reliable and accurate identification of background pixels without input from a human operator.

Referring again to FIG. 6, at steps S6-8 to S6-16, parameter setter 160 performs processing to read the colour values of the pixels selected at step S6-6 and to generate therefrom parameters defining characteristic colour values of background pixels for use in subsequent segmentation processing.

In this embodiment, parameter setter 160 builds a hash table of quantised values representing the colours of the selected pixels.

More particularly, at step S6-8, parameter setter 160 reads the RBG data values for the next pixel selected at step S6-6 (this being the first such pixel the first time step S6-8 is performed).

At step S6-10, parameter setter 160 calculates a quantised red (R) value, a quantised green (G) and a quantised blue (B) value for the pixel in accordance with the following equation:

$$q = \frac{( p + t / 2 )}{t} \qquad ( 1 )$$

where:

“q” is the quantised value;

“p” is the R, G or B value read at step S6-8;

“t” is a threshold value determining how near RGB values from an input image showing the subject object 210 need to be to background colours to be labelled as background. In this embodiment, “t” is set to 4.

At step S6-12, parameter setter 160 combines the quantised R, G and B values calculated at step S6-10 into a “triple value” in a conventional manner.

At step S6-14, parameter setter 160 applies a hashing function to the quantised R, G and B values calculated at step S6-10 to define a bin in a hash table, and adds the “triple” value defined at step S6-12 to the defined bin. More particularly, in this embodiment, parameter setter 160 applies the following hashing function to the quantised R, G and B values to define the bin in the hash table:

h(q)=(q_{red}&7)*2\hat{ }6+(q_{green}&7)*2\hat{ }3+(q_{blue}&7) (2)

That is, the bin in the hash table is defined by the three least significant bits of each colour. This function is chosen to try and spread out the data into the available bins in the hash table, so that each bin has only a small number of “triple” values. In this embodiment, at step S6-14, the “triple” value is added to the bin only if it does not already exist therein, so that each “triple” value is added only once to the hash table.

At step S6-14, parameter setter 160 determines whether there is another pixel selected at step S6-6 remaining to be processed. Steps S6-8 to S6-16 are repeated until each pixel selected at step S6-6 has been processed in the manner described above. As a result of this processing, a hash table is generated containing values representing the colours in the “background”.

Referring again to FIG. 4, at step S4-10, image data segmenter 70 uses the segmentation parameters comprising the hash table values defined by segmentation parameter calculator 60 at step S4-8 to segment image data relating to the subject object 210 from background image data in each input image 300-314.

FIG. 9 shows the processing operations performed by image data segmenter 70 in this embodiment at step S4-10.

Referring to FIG. 9, at steps S9-2 to S9-36., image data segmenter 70 selects each input image 300-314 in turn and uses the hash table generated at step S4-8 to segment the data in the input image relating to the subject object 210 from other image data (“background” image data).

More particularly, at step S9-2, image data segmenter 70 selects the next input image (this being the first input image the first time step S9-2 is performed).

In this embodiment, image data segmenter 70 classifies each pixel lying wholly outside the outer perimeter of the volume projection in the image (determined at step S6-6) as a “background” pixel (because subject object pixels must lie within the volume projection) and only performs subsequent segmentation processing on pixels lying at least partially within the outer perimeter of the volume projection. In this way, the number of pixels for which segmentation processing is to be performed is reduced, resulting in reduced processing time and increased accuracy (because the fewer pixels that require processing the less chance these is of erroneously classifying a pixel representing an artefact in the background as a subject object pixel).

Accordingly, at step S9-4 reads the R, G and B values for the next pixel lying at least partially within the outer perimeter of the volume projection in the selected input image (this being the first such pixel the first time step S9-4 is performed).

At step S9-6, image data segmenter 70 calculates a quantised R value, a quantised G value and a quantised B value for the pixel using equation (1) above.

At step S9-8, image data segmenter 70 combines the quantised R, G and B values calculated at step S9-6 into a “triple value”.

At step S9-10, image data segmenter 70 applies a hashing function in accordance with equation (2) above to the quantised values calculated at step S9-6 to define a bin in the hash table generated by segmentation parameter calculator 60 at step S4-8.

At step S9-12, image data segmenter 70 reads the “triple” values in the hash table bin defined at step S9-10, these “triple” values representing the colours of the background around the subject object 210.

At step S9-14, image data segmenter 70 determines whether the “triple” value generated at step S9-8 of the pixel in the input image currently being considered is the same as any of the background “triple” values in the hash table bin.

If it is determined at step S9-14 that the “triple” value of the pixel is the same as a background “triple” value, then, at step S9-16, it is determined that the pixel is a background pixel and the value of the pixel is set to “black”.

On the other hand, if it is determined at step S9-14 that the “triple” value of the pixel is not the same as any “triple” value of the background, then, at step S9-18, it is determined that the pixel is part of the subject object 210 and image data segmenter 70 sets the value of the pixel to “white”.

At step S9-20, image data segmenter 70 determines whether there is another pixel at least partially within the outer perimeter of the volume projection in the input image. Steps S9-4 to S9-20 are repeated until each such pixel has been processed in the way described above.

At steps S9-34 to S9-34, image data segmenter 70 performs processing to correct any errors in the classification of image pixels as background pixels or object pixels.

More particularly, at step S9-22, image data segmenter 70 defines a circular mask for use as a median filter.

In this embodiment, the circular mask has a radius of 4 pixels.

At step S9-24, image data segmenter 70 performs processing to place the centre of the mask defined at step S9-22 at the centre of the next pixel in the binary image generated at steps S9-16 and S9-18 (this being the first pixel the first time step S9-24 is performed).

At step S9-26, image data segmenter 70 counts the number of black pixels and the number of white pixels within the mask.

At step S9-28, image data segmenter 70 determines whether the number of white pixels within the mask is greater than or equal to the number of black pixels within the mask.

If it is determined at step S9-28 that the number of white pixels is greater than or equal to the number of black pixels, then, at step S9-30 image data segmenter 70 sets the value of the pixel on which the mask is centred to white. On the other hand, if it is determined at step S9-28 that the number of black pixels is greater than the number of white pixels then, at step S9-32, image data segmenter 70 sets the value of the pixel on which the mask is centred to black.

At step S9-34, image data segmenter 70 determines whether there is another pixel in the binary image, and steps S9-24 to S9-34 are repeated until each pixel has been processed in the way described above.

At step S9-36, image data segmenter 70 determines whether there is another input image to be processed. Steps S9-2 to S9-36 are repeated until each input image has been processed in the way described above.

Referring again to FIG. 4, at step S4-12, surface modeller 80 generates data defining a 3D computer model comprising a polygon mesh representing the surface shape of the subject object 210 by processing the segmented image data generated by image data segmenter 70 at step S4-10 and the position and orientation data generated by camera calculator 50 at step S4-6.

The segmentation data generated by image data segmenter 70 at step S4-10 defines the silhouette of the subject object 210 in each input image 300-314. Each silhouette defines, together with the focal point position of the camera when the image in which the silhouette is situated was recorded, an infinite cone in 3D space which touches the surface of the subject object 210 at (as yet unknown) points in the 3D space (because the silhouette defines the outline of the subject object surface in the image).

The processing performed by surface modeller 80 at step S4-12 in this embodiment to generate the polygon mesh representing the surface shape of the subject object 210 comprises processing to determine the volume of 3D space defined by the intersection of the infinite cones defined by all of the silhouettes in the input images, and to represent the intersection volume by a mesh of connected planar polygons.

This processing may be carried out using the technique described in the proprietor's co-pending European and US patent applications 02254027.2 (EP-A-1267309) and Ser. No. 10/164,435 (US 2002-0190982 A1) (the full contents of which are incorporated herein by cross-reference), or may be carried out using a conventional method, for example such as that described in “A Volumetric Intersection Algorithm for 3D-Reconstruction Using a Boundary-Representation” by Martin Löhlein at http://i31www.ira.uka.de/diplomarbeiten/da_martin_loehlein/Reconstruction.html or as described in “An Algorithm for Determining the Intersection of Two Simple Polyhedra” by M. Szilvasi-Nagy in Computer Graphics Forum 3 (1984) pages 219-225.

Alternatively, surface modeller 70 may perform shape-from-silhouette processing for example as described in “Looking to build a model world: automatic construction of static object models using computer vision” by Illingsworth and Hilton in Electronics and Communication Engineering Journal, June 1998, pages 103-113, or “Automatic reconstruction of 3D objects using a mobile camera” by Niem in Image and Vision Computing 17 (1999) pages 125-134. In these methods the intersections of the silhouette cones are calculated and used to generate a “volume representation” of the subject object made up of a plurality of voxels (cuboids). More particularly, 3D space is divided into voxels, and the voxels are tested to determine which ones lie inside the volume defined by the intersection of the silhouette cones. Voxels inside the intersection volume are retained to define a volume of voxels representing the subject object. The volume representation is then converted into a surface model comprising a mesh of connected polygons.

As a further alternative, surface modeller 70 may generate the 3D computer model of the subject object 210 using what is known as voxel carve processing, for example, as described in “Rapid Octree Construction from Image Sequences” by R. Szeliski in CVGIP: Image Understanding, Volume 58, Number 1, July 1993, pages 23-32 or voxel colouring processing, for example, as described in University of Rochester Computer Sciences Technical Report Number 680 of January 1998 entitled “What Do N Photographs Tell Us About 3D Shape?” and University of Rochester Computer Sciences Technical Report Number 692 of May 1998 entitled “A Theory of Shape by Space Carving”, both by Kiriakos N. Kutulakos and Stephen M. Seitz. In these techniques, data defining a 3D grid of voxels representing the volume of the subject object 210 is generated and the voxels are then processed to generate data defining a 3D surface mesh of triangles defining the surface of the object 210, for example using a conventional marching cubes algorithm, for example as described in W. E. Lorensen and H. E. Cline: “Marching Cubes: A High Resolution 3D Surface Construction Algorithm”, in Computer Graphics, SIGGRAPH 87 proceedings, 21: 163-169, July 1987, or J. Bloomenthal: “An Implicit Surface Polygonizer”, Graphics Gems IV, AP Professional, 1994, ISBN 0123361559, pp 324-350. The number of triangles in the surface mesh is then substantially reduced by performing a decimation process.

The result of the processing at step S4-12 is a polygon mesh representing the surface of the subject object 210. Because the polygon mesh is generated using the input images 300-314 as described above, the polygon mesh is registered to each input image (that is, the position and orientation of the polygon mesh is known relative to the position and orientation of each input images 300-314).

At step S4-14, texture data generator 90 processes the input images to generate texture data therefrom for the polygon mesh generated at step S4-12.

More particularly, in this embodiment, texture data generator 90 performs processing in a conventional manner to select each polygon in the polygon mesh generated at step S4-12 and to find the input image “i” which is most front-facing to the selected polygon. That is, the input image is found for which the value \hat{n}t. \hat{v}i is largest, where \hat{n}t is the polygon normal, and \hat{v}i is the viewing direction for the “i”th image. This identifies the input image 300-314 in which the selected surface polygon has the largest projected area.

The selected surface polygon is then projected into the identified input image, and the vertices of the projected polygon are used as texture coordinates to define an image texture map.

Other techniques that may be used by texture data generator 90 to generate texture data at step S4-14 are described in co-pending UK patent applications 0026331.9 (GB-A-2369541) and 0026347.5 (GB-A-2369260), and co-pending U.S. application Ser. No. 09/981,844 (US2002-0085748 A1) the full contents of which are incorporated herein by cross-reference.

The result of performing the processing described above is a 3D computer model comprising a polygon mesh modelling the surface shape of the subject object 210, together with texture coordinates defining image data from the input images to be rendered onto the model.

Referring again to FIG. 4, at step S4-16, output data interface 120 outputs data defining the 3D polygon mesh generated at step S4-12 and, optionally, the texture data generated at step S4-14.

The data is output from processing apparatus 2 for example as data stored on a storage medium 122 or as a signal 124 (as described above with reference to FIG. 1). In addition, or instead, renderer 100 may generate image data defining images of the 3D computer model generated at step S4-12 rendered with the texture data generated at step S4-14 in accordance with a virtual camera controlled by the user. The images may then be displayed on display device 4.

Modifications and Variations

Many modifications and variations can be made to the embodiment described above within the scope of the claims.

For example, in the embodiment described above, each input image comprises a “still” images of the subject object 210. However, the input images may comprise frames of image data from a video camera.

In the embodiment described above, at step S4-4, data input by a user defining the intrinsic parameters of the camera is stored. However, instead, default values may be assumed for one, or more, of the intrinsic camera parameters, or processing may be performed to calculate the intrinsic parameter values in a conventional manner, for example as described in “Euclidean Reconstruction From Uncalibrated Views” by Hartley in Applications of Invariance in Computer Vision, Mundy, Zisserman and Forsyth eds, pages 237-256, Azores 1993.

In the embodiment described above, all of the input images 300-314 processed at steps S4-6 to S4-12 to generate the 3D computer surface shape model comprise images of the subject object 210 on the photographic mat 34, and the processing by camera calculator 50 comprises processing to match features from the calibration pattern on the photographic mat 34 in the images with stored data defining the calibration pattern. In this way, the position and orientation of each input image is calculated relative to a reference position and orientation of the calibration pattern. However, instead, camera calculator 50 may perform processing to match features of the calibration pattern between images (instead of between an image and a stored pattern) to determine the relative positions and orientations of the input images. For example, a technique as described with reference to FIGS. 53 and 54 in co-pending PCT Application GB00/04469 (WO-A-01/39124) may be used. Alternatively, the input images processed at steps S4-6 to S4-12 may comprise images of the subject object 210 alone, without the photographic mat, and camera calculator 50 may perform processing at step S4-6 to calculate the relative positions and orientations of the input images by matching features on the subject object 210 itself (rather than matching features in the calibration pattern), for example as described in EP-A-0898245. In addition, camera calculator 50 may calculate the relative positions and orientations of the input images at step S4-6 using matching features in the images identified by the user (for example, by pointing and clicking to identify the position of the same feature in different images).

The processing performed at step S6-2 by 3D volume calculator 130 may be different to that described in the embodiment above. For example, the user may be requested at step S4-2 to input data defining the height of the subject object 210, and this data may be used at step S6-2 to define the position of the top plane of the cuboid 400 instead of projecting the line 410 from a focal point position of the camera through the top edge of an input image as described in the embodiment above. Alternatively, a subset (or all) of the input images may be selected and segmentation processing performed in a conventional way (for example by selecting pixels around the edge of each selected image as background pixels and using these background pixels to define the segmentation parameters in the same way as the selected pixels are processed in the embodiment described above to define the segmentation parameters) to define an approximate silhouette of the subject object in each selected image. The approximate silhouettes may then be processed using the processing described with reference to step S4-12 to generate a polygon mesh approximating the surface shape of the subject object 210. This polygon mesh may then be used as the volume in three-dimensional space enclosing the subject object for projection into at least one input image at step S6-4.

The processing performed by pixel selector 150 at step S6-6 to select background pixels in dependence upon the volume projection in each image may be different to that described in the embodiment above. For example, instead of selecting all of the pixels in each region 440, only a subset of the pixels in each region 440 may be selected. In addition, instead of selecting pixels within a region 440 of predetermined width around the outer perimeter of the volume projection, pixel selector 150 may be arranged to select a predetermined number of any of the pixels lying outside the outer perimeter 430 of the projection of the volume.

The processing at steps S4-8, S4-10 and S4-12 may be repeated to iteratively calculate image data segmentation parameters, segment the image data using the calculated segmentation parameters and generate data defining a polygon mesh representing the surface shape of the subject object 210, with the 3D volume enclosing the subject object being defined at step S6-2 on the second and each subsequent iteration to be the polygon mesh calculated at step S4-12 on the previous iteration. In this way, on each iteration, the 3D volume enclosing the subject object at step S6-2 more closely represents the actual volume of the subject object 210. The iteration of the processing at steps S4-8, S4-10 and S4-12 may be terminated, for example, after a fixed number of iterations.

Image data segmenter 70 may be arranged to perform a different image data segmentation technique at step S4-10 to the one described in the embodiment above, and consequently segmentation parameter calculator 60 may be arranged to calculate different image data segmentation parameters at step S4-8. More particularly, image data segmenter 70 may be arranged to perform any segmentation technique which distinguishes between “background” pixels and pixels of the subject object 210 by testing at least one image property that can distinguish between the two different types of pixels. For example, image properties which may be tested include pixel colours, image variation/uniformity over regions, and/or image boundaries. Segmentation parameter calculator 60 would be arranged to determine the corresponding image properties of “background” pixels to be used in any such segmentation technique based on the properties of the pixels selected by pixel selector 150 at step S6-6.

Surface modeller 80 (and, optionally, texture data generator 90 and renderer 100) may be located in an apparatus separate from processing apparatus 2. The output data output from processing apparatus 2 via output interface 120 may then comprise data defining the silhouette of the subject object 210 in each input image segmented by image data segmenter 70.

In the embodiment described above, processing is performed by a programmable computer using processing routines defined by programming instructions. However, some, or all, of the processing could, of course, be performed using hardware.

Other modifications are, of course, possible.

1. A method of processing data defining a plurality of images of an object recorded at different positions and orientations and data defining the positions and orientations to generate data defining a three-dimensional computer model of the object, the method comprising:
defining a volume in three-dimensional space enclosing the object;
determining the two-dimensional projection of the volume in at least one of the images;
selecting pixels from at least one image in dependence upon the volume projection therein;
determining segmentation parameters in dependence upon at least one image property of the selected pixels, the segmentation parameters comprising parameters for distinguishing between subject object image data and other image data during segmentation processing;
processing the image data to segment image data relating to the object from other image data in at least some of the images using the generated segmentation parameters; and
generating data defining a three-dimensional computer model of the object using the results of the segmentation processing and the data defining the positions and orientations at which the images were recorded.

2. A method according to claim 1, wherein the pixels are selected from an image by determining the position of the outer perimeter of the volume projection in the image and selecting pixels in dependence upon the determined outer perimeter position.

3. A method according to claim 2, wherein pixels are selected from an image by selecting pixels from a band adjacent the outer perimeter of the volume projection.

4. A method according to claim 1, wherein the processing operations are repeated at least once, and wherein, on the second and each subsequent time the operations are performed, the process of defining a volume in the three-dimensional space enclosing the object comprises defining the volume to be the three-dimensional computer model of the object generated a previous time the operations were performed.

5. A method according to claim 1, wherein, in the processing to segment image data relating to the object from other image data in an image, the segmentation processing using the generated segmentation parameters is performed only on image data within the projection of the volume in the image, and the image data outside the projection of the volume is classified as image data which does not relate to the object.

6. A method according to claim 1, wherein the segmentation parameters are determined in dependence upon the value of at least one colour component of each selected pixel.

7. A method according to claim 1, wherein:
each image to be processed shows the object together with a calibration object and the data defining the positions and orientations of the images defines the positions and orientations of the images and the position of the calibration object in the same three-dimensional coordinate system; and
the volume enclosing the object is defined in the three-dimensional coordinate system of the images and calibration object in dependence upon the calibration object.

8. A method according to claim 1, further comprising generating a signal carrying data defining the generated three-dimensional computer model.

9. A method according to claim 8, further comprising making a recording of the signal either directly or indirectly.

10. A method of processing data defining a plurality of images of an object recorded at different positions and orientations and data defining the positions and orientations to segment image data relating to the object from other image data in the images, the method comprising:
defining a volume in three-dimensional space enclosing the object;
determining the two-dimensional projection of the volume in at least one of the images;
selecting pixels from at least one image in dependence upon the volume projection therein;
determining segmentation parameters in dependence upon at least one image property of the selected pixels, the segmentation parameters comprising parameters for distinguishing between subject object image data and other image data during segmentation processing; and
segmenting image data relating to the object from other image data in at least some of the images using the generated segmentation parameters.

11. A method according to claim 10, further comprising generating a signal carrying data defining the silhouette of the subject object in each of the at least some images.

12. A method according to claim 11, further comprising making a recording of the signal either directly or indirectly.

13. An apparatus for processing data defining a plurality of images of an object recorded at different positions and orientations and data defining the positions and orientations to generate data defining a three-dimensional computer model of the object, the apparatus comprising:
a volume definer operable to define a volume in three-dimensional space enclosing the object;
a volume projector operable to determine a two-dimensional projection of the volume in at least one of the images;
a pixel selector operable to select pixels from at least one image in dependence upon the volume projection therein;
a segmentation parameter definer operable to determine segmentation parameters in dependence upon at least one image property of the selected pixels, the segmentation parameters comprising parameters for distinguishing between subject object image data and other image data during segmentation processing;
an image data segmenter operable to process the image data to segment image data relating to the object from other image data in at least some of the images using the generated segmentation parameters; and
a three-dimensional computer model data generator operable to generate data defining a three-dimensional computer model of the object using the results of the segmentation processing and the data defining the positions and orientations at which the images were recorded.

14. An apparatus according to claim 13, wherein said pixel selector is operable to select pixels from an image by determining the position of an outer perimeter of the volume projection in the image and selecting pixels in dependence upon the determined outer perimeter position.

15. An apparatus according to claim 14, wherein said pixel selector is operable to select pixels from an image by selecting pixels from a band adjacent the outer perimeter of the volume projection.

16. An apparatus according to claim 13, wherein the apparatus is operable to repeat the processing operations at least once, and wherein, on the second and each subsequent time the operations are performed, said volume definer is arranged to define the volume to be the three-dimensional computer model of the object generated a previous time the operations were performed.

17. An apparatus according to claim 13, wherein said image data segmenter is operable to perform segmentation processing using the generated segmentation parameters only on image data within the projection of the volume in the image, and to classify the image data outside the projection of the volume as image data which does not relate to the object.

18. An apparatus according to claim 13, wherein said segmentation parameter definer is operable to determine the segmentation parameters in dependence upon the value of at least one colour component of each selected pixel.

19. An apparatus according to claim 13, wherein:
each image to be processed shows the object together with a calibration object and the data defining the positions and orientations of the images defines the positions and orientations of the images and the position of the calibration object in the same three-dimensional coordinate system; and
said volume definer is operable to define the volume enclosing the object in the three-dimensional coordinate system of the images and calibration object in dependence upon the calibration object.

20. An apparatus for processing data defining a plurality of images of an object recorded at different positions and orientations and data defining the positions and orientations to segment image data relating to the object from other image data in the images, the apparatus comprising:
a volume definer operable to define a volume in three-dimensional space enclosing the object;
a projection calculator operable to determine the two-dimensional projection of the volume in at least one of the images;
a pixel selector operable to select pixels from at least one image in dependence upon the volume projection therein;
a segmentation parameter definer operable to determine segmentation parameters in dependence upon at least one image property of the selected pixels, the segmentation parameters comprising parameters for distinguishing between subject object image data and other image data during segmentation processing; and
an image data segmenter operable to segment image data relating to the object from other image data in at least some of the images using the generated segmentation parameters.

21. An apparatus for processing data defining a plurality of images of an object recorded at different positions and orientations and data defining the positions and orientations to generate data defining a three-dimensional computer model of the object, the apparatus comprising:
means for defining a volume in three-dimensional space enclosing the object;
means for determining the two-dimensional projection of the volume in at least one of the images;
means for selecting pixels from at least one image in dependence upon the volume projection therein;
means for determining segmentation parameters in dependence upon at least one image property of the selected pixels, the segmentation parameters comprising parameters for distinguishing between subject object image data and other image data during segmentation processing;
means for processing the image data to segment image data relating to the object from other image data in at least some of the images using the generated segmentation parameters; and
means for generating data defining a three-dimensional computer model of the object using the results of the segmentation processing and the data defining the positions and orientations at which the images were recorded.

22. An apparatus for processing data defining a plurality of images of an object recorded at different positions and orientations and data defining the positions and orientations to segment image data relating to the object from other image data in the images, the apparatus comprising:
means for defining a volume in three-dimensional space enclosing the object;
means for determining the two-dimensional projection of the volume in at least one of the images;
means for selecting pixels from at least one image in dependence upon the volume projection therein;
means for determining segmentation parameters in dependence upon at least one image property of the selected pixels, the segmentation parameters comprising parameters for distinguishing between subject object image data and other image data during segmentation processing; and
means for segmenting image data relating to the object from other image data in at least some of the images using the generated segmentation parameters.

23. A storage medium storing computer program instructions to program a programmable processing apparatus to become operable to perform a method as set out in any one of claims 1 to 7 and 10.

24. A signal carrying computer program instructions to program a programmable processing apparatus to become operable to perform a method as set out in any one of claims 1 to 7 and 10.
